(19) United States
(12) Patent Application Publication
(10) Pub. No.: US 2011/0195879 A1
(43) Pub. Date: Aug. 11, 2011

(54) INERT WEAR RESISTANT FLUOROPOLYMER-BASED SOLID LUBRICANTS, METHODS OF MAKING AND METHODS OF USE

(76) Inventor: Wallace Gregory Sawyer, Gainesville, FL (US)

(21) Appl. No.: 13/125,078

(22) PCT Filed: Nov. 17, 2009
(86) PCT No.: PCT/US09/64739

§ 371 Date: Apr. 20, 2011

Related U.S. Application Data
(60) Provisional application No. 61/115,251, filed on Nov. 17, 2008.

(51) Int. Cl. C08F 14/26; C10M 103/00; C10M 103/04; C08F 8/00

(52) U.S. Cl. 508/138; 508/151; 508/181; 525/55; 525/342; 525/366; 525/370

(57) ABSTRACT

The present disclosure includes fluoropolymer-based materials, methods of making fluoropolymer-based materials, methods of using fluoropolymer-based materials, and the like.

### CROSS-REFERENCE TO RELATED APPLICATION

This application claims priority to U.S. provisional application entitled, “INERT WEAR RESISTANT PTFE-BASED SOLID LUBRICANT,” having Ser. No. 61/115,251, filed on Nov. 17, 2008, which is entirely incorporated herein by reference.

### STATEMENT REGARDING FEDERALLY SPONSORED RESEARCH OR DEVELOPMENT

This invention was made with government support under Grant No.: FA9550-04-1-0367 awarded by the United States Air Force/Air Force Office of Scientific Research. The government has certain rights in the invention.

### FIELD OF THE DISCLOSURE

This disclosure relates to inert fluoropolymer-based low wear materials.

### BACKGROUND

Polytetrafluoroethylene (PTFE) exhibits desirable tribological characteristics, including low friction, high melting temperature and chemical inertness. Based on these characteristics, PTFE is a frequently used solid lubricant both as a filler and matrix material. Without a filler, however, PTFE suffers from a relatively high wear rate, generally precluding its use in frictional applications, including use as a bearing material.

As a matrix material, PTFE has been successfully filled with various nanoparticles, including alumina, zinca, and carbon nanotubes. Regarding alumina filling, Sawyer et al. [Sawyer, W. G., Freudenburg, K. D., Bhimaraj, P., and Schadler, L. S., (2003), “A Study on the Friction and Wear of Ptfe Filled with Alumina Nanoparticles,” Wear, 254, pp. 573-580] discloses 38 nm substantially spherical shaped Al₂O₃ filler particles for improving the wear performance of PTFE. The wear resistance of this nanocomposite was reported to increase monotonically with filler wt %, eventually being 600 times more wear resistant than unfilled PTFE at a loading of 20 wt. % Al₂O₃. Although the wear performance provided by PTFE/alumina nanocomposites disclosed by Sawyer et al. represents a major improvement over PTFE, the high filler percentage required to reach the desired wear level significantly raises the cost of the nanocomposite. In addition, for certain applications wear rates lower than 600 times better those of PTFE are desirable or wear rates lower than those achieved by PTFE/Al₂O₃. Accordingly, a PTFE nanocomposites is needed which provides improved wear resistance, while at the same time requiring a lower filler percentage as compared to the PTFE nanocomposites disclosed by Sawyer et al.

### SUMMARY

Embodiments of the present disclosure include fluoropolymer-based materials, method of making fluoropolymer-based materials, and methods of using fluoropolymer-based materials, and the like.

In an embodiment, the fluoropolymer-based material includes a fluoropolymer comprising a major phase including a minor phase comprising a fluorine-reactive compound, wherein the fluoropolymer-based material is inert.

In an embodiment, the method of making a fluoropolymer-based material, includes admixing a fluoropolymer with a fluorine-reactive compound; and heating the admixture to form a fluoropolymer-based material having a fluoropolymer major phase intermixed with a minor phase comprising the fluorine-reactive compound, and wherein the fluoropolymer-based material is inert.

### BRIEF DESCRIPTION OF THE DRAWINGS

A fuller understanding of the present invention and the features and benefits thereof will be accomplished upon review of the following detailed description together with the accompanying drawings.

FIG. 1 shows a schematic of the tribometer used for friction and wear testing of PTFE-based materials according to the present disclosure described in the Examples provided herein.

FIG. 2 shows the wear rate and friction coefficient for nickel filled PTFE plotted vs wt % Ni in PTFE.

### DETAILED DESCRIPTION

Before the present disclosure is described in greater detail, it is to be understood that this disclosure is not limited to particular embodiments described, as such may, of course, vary. It is also to be understood that the terminology used herein is for the purpose of describing particular embodiments only, and is not intended to be limiting, since the scope of the present disclosure will be limited only by the appended claims.

Where a range of values is provided, it is understood that each intervening value, to the tenth of the unit of the lower limit (unless the context clearly dictates otherwise), between the upper and lower limit of that range, and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present disclosure is not entitled to antedate such publication by virtue of prior disclosure. Further, the dates of publication provided could be different from the actual publication dates that may need to be independently confirmed.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

Embodiments of the present disclosure will employ, unless otherwise indicated, techniques of chemistry, synthetic organic chemistry, biochemistry, biology, molecular biology, and the like, which are within the skill of the art. Such techniques are explained fully in the literature.

The following examples are put forth so as to provide those of ordinary skill in the art with a complete disclosure and description of how to perform the methods and use the compositions and compounds disclosed and claimed herein. Efforts have been made to ensure accuracy with respect to numbers (e.g., amounts, temperature, etc.), but some errors and deviations should be accounted for. Unless indicated otherwise, parts are parts by weight, temperature is in ° C., and pressure is at or near atmospheric. Standard temperature and pressure are defined as 20° C. and 1 atmosphere.

Before the embodiments of the present disclosure are described in detail, it is to be understood that, unless otherwise indicated, the present disclosure is not limited to particular materials, reagents, reaction materials, manufacturing processes, or the like, as such can vary. It is also to be understood that the terminology used herein is for purposes of describing particular embodiments only, and is not intended to be limiting. It is also possible in the present disclosure that steps can be executed in different sequence where this is logically possible.

It must be noted that, as used in the specification and the appended claims, the singular forms “a,” “an,” and “the” include plural referents unless the context clearly dictates otherwise. Thus, for example, reference to “a support” includes a plurality of supports. In this specification and in the claims that follow, reference will be made to a number of terms that shall be defined to have the following meanings unless a contrary intention is apparent.

### Discussion:

Embodiments of the present disclosure include fluoropolymer-based materials, methods of making fluoropolymer-based materials, methods of using fluoropolymer-based materials, and the like. Embodiments of the present disclosure provide for fluoropolymer-based materials that have enhanced wear resistance at lower loading and are less expensive than similar materials.

Embodiments of the fluoropolymer-based material (e.g., a polytetrafluoroethylene (PTFE)-based material) can include a fluoropolymer (e.g., PTFE) admixed with a fluorine-reactive compound. The fluorine-reactive compound can include a single reactive compound or a combination of reactive compounds. The fluorine-reactive compound may not be inert by itself but after reacting with the fluoropolymer results in an inert fluoropolymer-based material. The term “inert” as it refers to the fluoropolymer-based material means that the “inert fluoropolymer-based material” retains the inherent inertness of its PTFE predecessor. This means the material is stable and does not react or degrade with exposure to environments of air, water, acids, bases, and other organic materials. Embodiments of the fluoropolymer-based material can have a wear rate of about 10⁻³ to 10⁻⁹ mm²/(N*m), about 10⁻⁵ to 10⁻⁹ mm²/(N*m), or about 5×10⁻⁶ to 10⁻⁹ mm²/(N*m). Friction coefficients can vary from less than 0.1 and go up to above 0.35. In an embodiment, the friction coefficient is about 0.01 to 0.45, about 0.05 to 0.4, or about 0.1 to 0.35.

In one embodiment, the fluoropolymer (e.g., PTFE) can be a major phase of the resulting fluoropolymer-based material (e.g., PTFE-based material), which is intermixed by a minor phase comprising the fluorine-reactive compound, resulting in an inert fluoropolymer-based low wear composite material. The major phase can be about 90 to 99.99 weight percent of the composite, while the minor phase can be less than about 1 to 10 weight percent of the composite.

The term “fluoropolymer” can include a polymer having at least one fluorine-containing monomer and can be a homopolymer, a copolymer, and a terpolymer, and derivatives of each, and composites of each, as well as combinations thereof. Embodiments of the fluoropolymer can include polymers such as, but not limited to, polytetrafluoroethylene (PTFE), fluorinated ethylene-propylene (FEP), perfluoroalkoxy polymer resin (PFA), polychlorotrifluoroethylene (PCTFE), polytrifluoroethylene, polyvinylidene fluoride (PVDF), polyvinyl fluoride (PVF), tetrafluoroethylene-ethylene copolymer resin (ETFE), fluoroethylene propylene ether resin (EPE), copolymers of each, terpolymers of each, and the like. In an embodiment, the fluoropolymer can be PTFE, PFA, FEP, copolymers of each, terpolymers of each, or a combination thereof, where PTFE, PFA, and FEP refer to a chemical that can be used to form Teflon®. In an embodiment, the fluoropolymer is PTFE.

As used herein, the term “PTFE” includes polytetrafluoroethylene as well as its derivatives, composites and copolymers thereof, wherein the bulk of the copolymer material can be polytetrafluoroethylene, including copolymers of tetrafluoroethylene and hexafluoro(propyl vinyl ether), copolymers of tetrafluoroethylene and perfluoro-2,2-dimethyl-1,3-dioxole, and copolymers of tetrafluoroethylene and vinyl fluoride, poly(vinyl fluoride), poly(vinylidene fluoride), polychlorotrifluoroethylene, vinyl fluoride/vinylidene fluoride copolymer, vinylidene fluoride/hexafluoroethylene copolymer, perfluoroalkoxy polymer resin (PFA), and/or fluorinated ethylene-propylene (FEP). Where the term “PTFE” is used herein to describe polytetrafluoroethylene that is copolymerized with one of the above-named polymers, it is contemplated that the actual polytetrafluoroethylene content in the copolymer can be about 80% by weight, or higher, although lower amounts are also contemplated depending on the desired properties of the resulting PTFE-based compound.

The fluorine-reactive compound can be a variety of materials that can react with the fluorine of the fluoropolymer (e.g., PTFE), while maintaining the resulting material as inert. The fluorine-reactive compound can be in the form of a powder, particles, vapor, liquid, or a combination thereof. In an embodiment, the fluorine-reactive compound can include a nanoparticle or microparticle having a fluorine-reactive compound disposed on surface of the nanoparticle or microparticle.

In an embodiment the fluorine-reactive compound can comprise alkali metals, compounds of alkali metals and alloys of alkali metals including lithium, potassium, and/or rubidium.

In another embodiment, the fluorine-reactive compound can comprise alkaline earth metals, compounds of alkaline earth metals and alloys of alkaline earth metals including beryllium, magnesium, calcium, strontium, barium, and/or radium.

In another embodiment, the fluorine-reactive compound can include other metals and/or metal-based compounds for the fluorine-reactive compound including iron and iron-based compounds, nickel and nickel based compounds, and the like.

In another embodiment, the fluorine-reactive compound can be derived from inert materials, such as oxides, that still have some favorable reactivity with the PTFE, such as silica, alumina, and the like, which are then processed so that they become reactive to the fluorine of the fluoropolymer (e.g., PTFE). These inert materials can have a diameter of about 1 nm to 1000 nm.

In an embodiment, the inert compound can have its particles coated with a fluorine-reactive material (e.g., alkali metals, alkaline earth metals, and the like, such as those described above) so that the resulting particles can react with the fluoropolymer. Various combinations of inert compounds and fluorine-reactive coatings can be utilized based on a number of different factors, including the desired properties of the resulting fluoropolymer-based compound. Examples include a non-reactive particle treated with siloxane, or treating agents containing fluoropolymer reactive constituents.

The amount of the fluorine-reactive compound in the composite can vary depending on the intended use, for example. In an embodiment, the fluorine-reactive compound can be about 10 weight % of the composite or less, such as about 1, about 2, about 3, about 4, about 5, about 6, about 7, about 8, about 9 or about 10 weight % of the composite.

In an embodiment, the fluorine-reactive compound can be less than about 1 weight % of the composite. However, the present disclosure contemplates other amounts of the fluorine-reactive compound being used based on a number of different factors, including the desired properties of the resulting fluoropolymer-based compound.

In one embodiment, materials can be processed to result in a fluorine-reactive compound, which can then be processed with the fluoropolymer (e.g., PTFE) to result in an inert fluoropolymer-based low wear composite material. The particular processing steps can vary and can include sintering, heat treatment, and/or pressure treatment. For instance, metal precursors (e.g., titanium-based and/or tin-based compounds) can be processed with oxidizing agents resulting in the fluorine-reactive compound, which can then be processed with the fluoropolymer to result in an inert fluoropolymer-based low wear composite material. The exemplary embodiments can include processing powders to provide the fluorine-reactive compound, however, the present disclosure contemplates other processing techniques, including processing vapors of one or more of these materials and mixing them with the fluoropolymer, which can then result in an inert fluoropolymer-based low wear composite material.

In yet another embodiment, metals oxides, including, but not limited to, titanium dioxide, zinc oxide, zirconium oxide and/or aluminum oxide (e.g., alumina) can be mixed with the fluoropolymer (e.g., PTFE) and/or the fluorine-reactive compound in the exemplary embodiments, and can be processed in various ways, including the techniques described above. In one embodiment, alpha-phase alumina can be mixed with the fluoropolymer, which results in an inert fluoropolymer-based low wear composite material.

The particular shape of the particles used for the fluorine-reactive compound and/or for processing the fluoropolymer (e.g., PTFE) with the fluorine-reactive compound can vary, including substantially (e.g., about 70, 80, 90, 95%) spherical-shaped particles, irregular-shaped particles, and combinations of the two. As used herein, the term “irregular shape” refers to non-spherical shaped particles, such as the shapes produced by crushing or milling action. The particles of irregular shape thus can have asperities, points, and edges, as well as some flat areas. Such particles are available commercially, such as from Nanophase Technologies Corporation, Romeoville, Ill. or Alfa-Aesar (Ward Hill, Mass.), or can be formed by milling. In one embodiment, a combination of spherical-shaped and irregular-shaped particles can be used as the fluorine-reactive compound, where the percentage of each (e.g., a ratio of about 10:90 to 90:10 (spherical to irregular-shaped particles)) can be based on a number of different factors, including the desired properties of the resulting fluoropolymer-based compound. The particular size or diameter of the particles of the fluorine-reactive compound can vary based on a number of factors, including the desired properties of the fluoropolymer-based compound, and can be uniform or varied. In an embodiment, the diameter (or length of the longest dimension across the particle) can be about 1 nm to 1000 nm or about 10 nm to 250 nm.

In one embodiment, the resulting fluoropolymer-based compound is highly chemically inert; derived in part from the highly non-reactive nature of the fluoropolymer. For example, a fluorine-reactive compound can be utilized that is not inert by itself but after reacting with the fluoropolymer results in an inert compound.

Very caustic environments may necessitate the use of fluoropolymer (e.g., PTFE) which wears very rapidly, making frequent replacement a necessity. The addition of fluorine-reactive particles in composites according to the exemplary embodiments can increase the wear resistance of the fluoropolymer without sacrificing chemical inertness. Nanoparticles can have the advantages of non-abrasiveness, and high number density at low filler weight percentage.

The exemplary embodiments can be useful for a wide variety of applications whenever friction occurs and caustic chemicals are used, such as for fittings, bushings, and valves. The semiconductor industry has processes where fluoropolymer is currently used at great expense for etching chemicals.

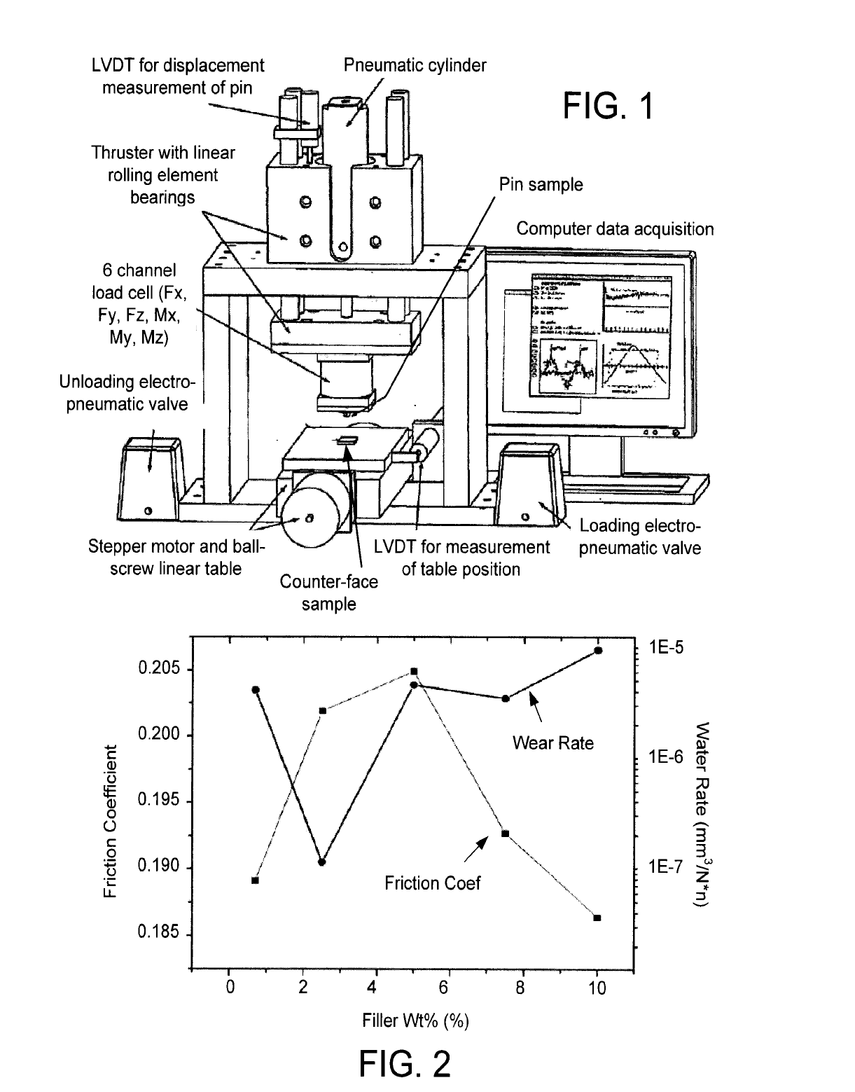

Wear and friction tests can be performed on fluoropolymer (e.g., PTFE) nanocomposites developed using the materials and techniques of the exemplary embodiment by utilizing the linear reciprocating tribometer shown in FIG. 1. Testing surfaces can include various finishing processes, such as electro-polishing, lapping, wet-sanding, and dry-sanding. The electro-polished samples can be prepared by wet-sanding with 600 grit silicon-carbide paper, followed by lapping, and finished by electro-polishing. Similarly, the lapped samples can be initially wet sanded with the 600 grit silicon-carbide paper and then lapped. The wet-sanded samples can be exposed only to the 600 grit silicon-carbide paper. The dry-sanded samples can be initially wet sanded and then roughened with 80 grit “coarse” silicon-carbide paper. The samples can be examined under a scanning white light interferometer. Various other techniques and devices can be utilized for testing of the exemplary fluoropolymer-based compounds and/or for formation of these compounds, such as based on the techniques, materials, and components described in U.S. Patent Publication No. 200701005726 to Sawyer et al, which was published on May 10, 2007 and the disclosure of which is hereby incorporated by reference. Additionally, the present disclosure can utilize techniques, materials, and components described in Sawyer, W. G., Freudenburg, K. D., Bhimaraj, P., and Schadler, L. S., (2003), “A Study on the Friction and Wear of Ptfe Filled with Alumina Nanoparticles,” Wear, 254, pp. 573-580, the disclosure of which is hereby incorporated by reference.

In one embodiment, an etching process can be employed to facilitate formation of the fluoropolymer-based material. For example, the fluoropolymer can be chemically and/or mechanically etched. In one embodiment, a surface of the fluoropolymer can be etched using a sliding rigid counterface having a fluorine-reactive compound thereon, including sodium, lithium, magnesium and/or other compounds such as those described with respect to the other exemplary embodiments. Other mechanical etching devices and/or techniques can be utilized, as well as chemical etching techniques.

### Examples

FIG. 2 is a graph of the wear rate and friction coefficient for nickel filled PTFE plotted vs wt % Ni in PTFE. Table 1 shows the wear rate and friction coefficient for Nickel filled PTFE for various Ni weight percentages.

TABLE 1

| Filler Wt % | Friction Coefficient | Wear Rate (mm\hat{ }3/N * m) |
|---|---|---|
| 0.7 | 0.1891 | 4.1E−6 |
| 2.5 | 0.2019 | 1.1383E−7 |
| 5 | 0.2049 | 4.6E−6 |
| 7.5 | 0.1927 | 3.4572E−6 |
| 10 | 0.1864 | 9.4987E−6 |

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. The term “about” can include ±1%, ±2%, ±3%, ±4%, ±5%, ±6%, +7%, ±8%, ±9%, or ±10%, or more of the numerical value(s) being modified. In addition, the phrase “about ‘x’ to ‘y’” includes “about ‘x’ to about ‘y’”.

It should be emphasized that the above-described embodiments of the present disclosure are merely possible examples of implementations, and are set forth only for a clear understanding of the principles of the disclosure. Many variations and modifications may be made to the above-described embodiments of the disclosure without departing substantially from the spirit and principles of the disclosure. All such modifications and variations are intended to be included herein within the scope of this disclosure.

1. A fluoropolymer-based material comprising:
a fluoropolymer comprising a major phase including a minor phase comprising a fluorine-reactive compound, wherein the fluoropolymer-based material is inert.

2. The material of claim 1, wherein the fluoropolymer is polytetrafluoroethylene (PTFE).

3. The material of claim 1, wherein the fluorine-reactive compound includes an alkali metal or an alkaline earth metal.

4. The material of claim 1, wherein the fluorine-reactive compound is selected from the group consisting of: an iron-based compound, a silica-based compound, an alumina-based compound, and a combination thereof.

5. The material of claim 1, wherein the fluorine-reactive compound comprises an inert compound having nanoparticles with a fluorine-reactive compound disposed thereon.

6. The material of claim 5, wherein the nanoparticle is selected from the group consisting of: a gold nanoparticle, a silica nanoparticle, a nickel nanoparticle, and a combination thereof.

7. The material of claim 1, wherein the minor phase comprises less than 10 weight % of fluoropolymer-based material.

8. The material of claim 1, wherein the fluorine-reactive compound comprises at least one of barium, calcium, and iron.

9. The material of claim 1, wherein the fluorine-reactive compound comprises at least one of lithium and sodium.

10. The material of claim 1, wherein the fluorine-reactive compound comprises at least one of strontium, potassium, magnesium, and barium.

11. The material of claim 1, wherein the fluorine-reactive compound comprises nanoparticles, and wherein at least a portion of the nanoparticles are spherical shaped.

12. The material of claim 1, wherein the fluorine-reactive compound comprises at least one of barium, calcium, iron, lithium, sodium, strontium, potassium, and magnesium.

13. A method of making a fluoropolymer-based material, comprising:
admixing a fluoropolymer with a fluorine-reactive compound; and
heating the admixture to form a fluoropolymer-based material having a fluoropolymer major phase intermixed with a minor phase comprising the fluorine-reactive compound, and wherein the fluoropolymer-based material is inert.

14. The method of claim 13, wherein the fluoropolymer is polytetrafluoroethylene (PTFE).

15. The method of claim 13, wherein the fluorine-reactive compound includes an alkali metal or an alkaline earth metal.

16. The method of claim 13, wherein the fluorine-reactive compound is selected from the group consisting of: an iron-based compound, a silica-based compound, an alumina-based compound, and a combination thereof.

17. The method of claim 13, further comprising forming the fluorine-reactive compound by applying a fluorine-reactive coating to nanoparticles of an inert compound.

18. The method of claim 17, wherein the nanoparticle is selected from the group consisting of: a gold nanoparticle, a silica nanoparticle, a nickel nanoparticle, and a combination thereof.

19. The method of claim 13, wherein the minor phase comprises less than 10 wt. % of said fluoropolymer-based material.

20. The method of claim 13, wherein the fluorine-reactive compound comprises at least one of barium, calcium, and iron.

21. The method of claim 13, wherein the fluoropolymer-based material comprises at least one of lithium, and sodium.

22. The method of claim 13, wherein the fluorine-reactive compound comprises at least one of strontium, potassium, magnesium, and barium.

23. The method of claim 13, further comprising processing an inert compound to form the fluorine-reactive compound, wherein the inert compound has high wear resistance.

24. The method of claim 13, wherein the heating step comprises compression molding.

25. The method of claim 13, wherein the admixing step is performed by jet milling.

26. The method of claim 13, further comprising admixing the fluoropolymer with the fluorine-reactive compound using an etching process applied to the fluoropolymer.
